(19) United States
(12) Patent Application Publication
(10) Pub. No.: US 2019/0103997 A1
(43) Pub. Date: Apr. 4, 2019

(54) SYMBOL RATE ESTIMATION DEVICE AND SYMBOL RATE ESTIMATION METHOD

(71) Applicant: MStar Semiconductor, Inc., Hsinchu Hsien (TW)

(72) Inventors: Ting-Nan CHO, Hsinchu Hsien (TW); Kai-Wen CHENG, Hsinchu Hsien (TW); Tai-Lai TUNG, Hsinchu Hsien (TW)

(21) Appl. No.: 15/995,179

(22) Filed: Jun. 1, 2018

(30) Foreign Application Priority Data
Sep. 29, 2017 (TW) 106133492

(51) Int. Cl. H04L 25/02; H04L 27/00; H04B 1/709

(52) U.S. Cl. CPC H04L 25/0262; H04L 27/0012; H04L 7/042; H04L 25/024; H04B 1/709

(57) ABSTRACT

A symbol rate estimation device includes: a power spectrum density (PSD) generating unit, estimating a power of an input signal to generate a PSD; a cut-off frequency index outputting unit, outputting a cut-off frequency index according to the power; and a symbol rate calculating unit, calculating a symbol rate of the input signal according to the cut-off frequency index.

This application claims the benefit of Taiwan application Serial No. 106133492, filed on Sep. 29, 2017, the subject matter of which is incorporated herein by reference.

### BACKGROUND OF THE INVENTION

### Field of the Invention

The invention relates to a symbol rate estimation device, and more particularly to a symbol rate estimation device applicable to satellite communication standards.

### Description of the Related Art

In satellite communication standards, e.g., Digital Video Broadcasting-Satellite (DVB-S), Digital Video Broadcasting-Satellite Second Generation (DVB-S2), and Digital Video Broadcasting-Satellite Second Generation Extension (DVB-S2X), a receiving end needs to estimate a symbol rate used by a transmitting end in order to demodulate received signals. In general, a receiving end estimates the symbol rate according to a power spectrum density (PSD) of received signals. However, when imbalance exists in the PSD of received signals, the accuracy of the estimated symbol rate in a receiving end may be lowered.

### SUMMARY OF THE INVENTION

The invention is directed to a more accurate symbol rate estimation method and method.

The present invention discloses a symbol rate estimation device, including: a power density spectrum (PSD) generating unit, estimating a power of an input signal to generate a PSD, which includes a plurality of powers respectively corresponding to a plurality of frequency indices; a cut-off frequency index outputting unit, outputting a cut-off frequency index according to the PSD; and a symbol rate calculating unit, calculating a symbol rate of the input signal according to the cut-off frequency index.

The present invention further discloses a symbol rate estimation method, including: estimating a power of an input signal to generate a PSD, which includes a plurality of powers respectively corresponding to a plurality of frequency indices; outputting a cut-off frequency index according to the PSD; and calculating the symbol rate of the input signal according to the cut-off frequency index.

The above and other aspects of the invention will become better understood with regard to the following detailed description of the embodiments. The following description is made with reference to the accompanying drawings.

### BRIEF DESCRIPTION OF THE DRAWINGS

FIG. 1 is a block diagram of a symbol rate estimation device according to an embodiment of the present invention;

FIG. 2 is a schematic diagram of an example of a power spectrum density (PSD) of an input signal;

FIG. 3 is a block diagram of a cut-off frequency index outputting unit;

FIG. 4 is a schematic diagram of an example of an imbalanced PSD;

FIG. 5 is a block diagram of a maximum power outputting unit according to an embodiment of the present invention;

FIG. 6 is a schematic diagram of an example of an imbalanced PSD;

FIG. 7 is a block diagram of a maximum power determining unit according an embodiment of the present invention; and

FIG. 8 is a flowchart of a maximum power determining method according an embodiment of the present invention.

### DETAILED DESCRIPTION OF THE INVENTION

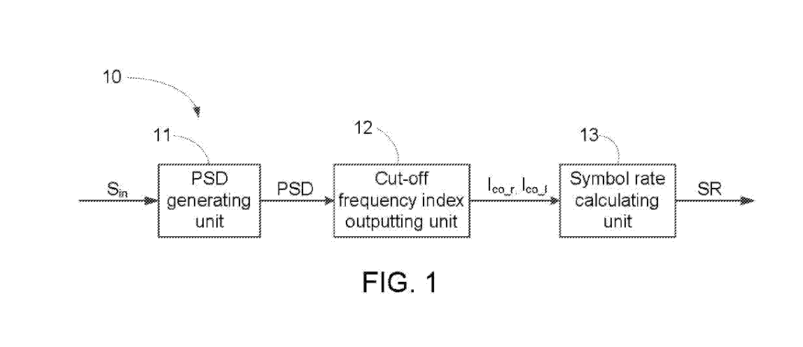

FIG. 1 shows a block diagram of a symbol rate estimation device 10 according to an embodiment of the present invention. The symbol rate estimation device 10 includes a power spectrum density (PSD) generating unit 11, a cut-off frequency index outputting unit 12 and a symbol rate calculating unit 13.

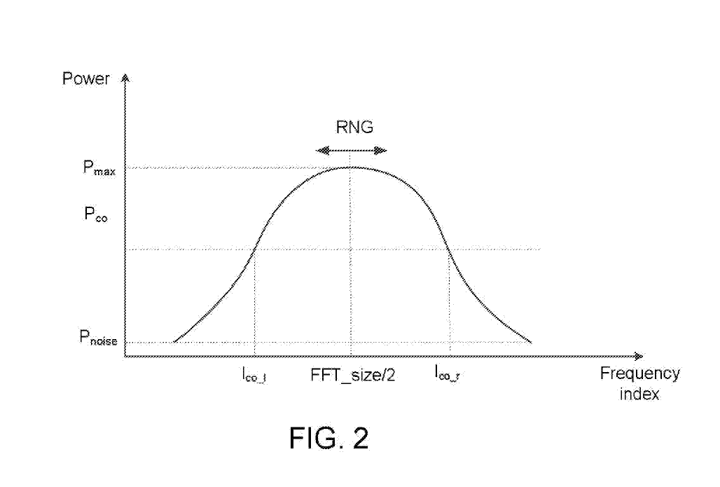

The PSD generating unit 11 estimates a power of an input signal to generate a PSD. In one embodiment, the PSD generating unit 11 first performs Fourier transform on an input signal Sᵢₙ to generate a transformed signal, and estimates the power of the input signal Sᵢₙ according to the transformed signal to generate the PSD. FIG. 2 shows a schematic diagram of an example of the PSD of an input signal. In FIG. 2, the horizontal axis represents frequency index and the vertical axis represents power. The PSD includes a plurality of powers respectively corresponding to a plurality of frequency indices. Thus, the power corresponding to each frequency index can be known according to the PSD. It should be noted that, the PSD generating unit 11 can usually be implemented by, but not limited to, a dedicated hardware circuit, and it can also be implemented by a software program. Further, various hardware implementation details of the PSD generating unit 11 are generally known to one person skilled in the art, and shall be omitted herein.

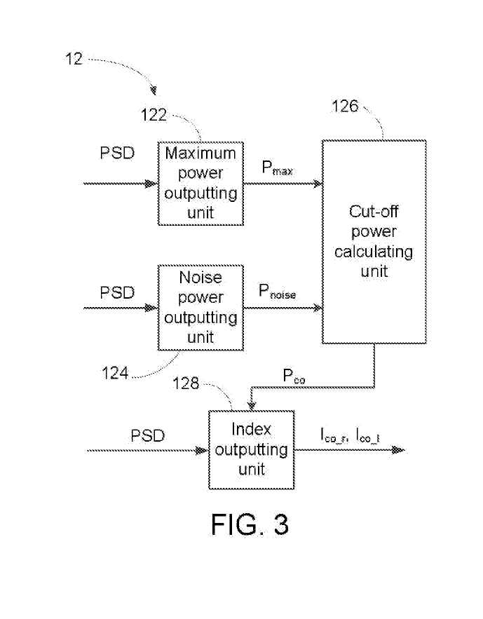

The cut-off frequency index outputting unit 12 outputs cut-off frequency indices I_{co}_{_}ᵣ and I_{co}_{_}ₗ according to the PSD generated by the PSD generating unit 11. FIG. 3 shows a block diagram of the cut-off frequency index outputting unit 12. Referring to FIG. 3, in one embodiment, the cut-off frequency index outputting unit 12 includes a maximum power outputting unit 122, a noise power outputting unit 124, a cut-off power calculating unit 126 and an index outputting unit 128. The maximum power outputting unit 122 outputs a maximum power Pₘₐₓ according to the PSD. For example, referring to FIG. 2, the maximum power Pₘₐₓ is a maximum power in a search range RNG of the PSD, wherein the RND regards, for example, FFT_size/2 as a center thereof, and FFT_size is a resolution that the PSD generating unit 11 uses to perform the Fourier transform on the input signal. The noise power outputting unit 124 outputs a noise power Pₙₒᵢₛₑ according to the PSD. For example, referring to FIG. 2, the power noise Pₙₒᵢₛₑ is an average of two minimum powers on two sides of the PSD. Next, the cut-off frequency calculating unit 126 calculates a cut-off power P_{co} (e.g., a 3 db cut-off power) according to the maximum power Pₘₐₓ and the noise power Pₙₒᵢₛₑ. In one embodiment, the cut-off power P_{co} is an average of the maximum power Pₘₐₓ and the noise power Pₙₒᵢₛₑ. The index outputting unit 128 then outputs the frequency index corresponding to the cut-off power P_{co} as the cut-off frequency indices I_{co}_{_}ᵣ and I_{co}_{_}ₗ, as shown in FIG. 2

The symbol rate calculating unit 13 calculates a symbol rate SR of the input signal Sᵢₙ according to the cut-off frequency indices I_{co}_{_}ᵣ and I_{co}_{_}ₗ outputted by the cut-off frequency index outputting unit 12. In one embodiment, the symbol rate may be calculated according to equation (1):

SR=((I_{co}_{_}ᵣ−I_{co}_{_}ₗ)/FFT_size)*Fs (1)

In equation (1), Fs is a sampling rate according to which the receiving end samples the input signal Sᵢₙ. The symbol rate calculating unit 13 may usually be implemented by a dedicated hardware circuit, or by a software program. Further, various hardware implementation details of the symbol rate calculating unit 13 are generally known to one person skilled in the art, and shall be omitted herein.

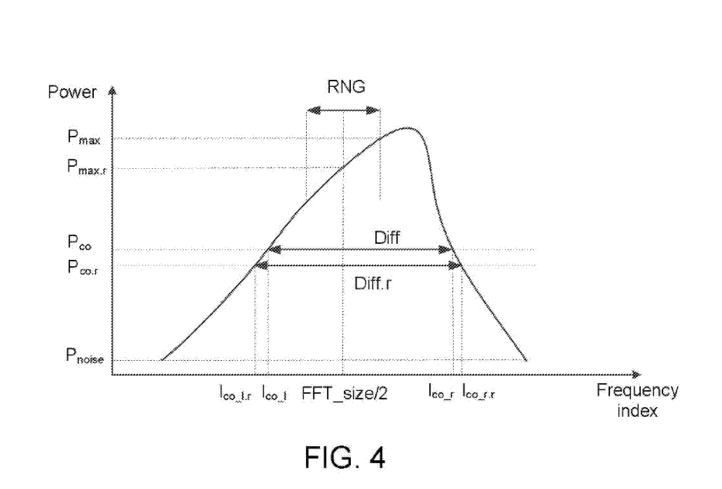

When the PSD is imbalanced, the PSD is inclined towards one side. For example, FIG. 4 shows a schematic diagram of an imbalanced PSD. As shown in FIG. 4, the PSD inclines towards the right side. In this situation, the maximum power Pₘₐₓ outputted by the maximum power output unit 122 according to the PSD is greater than a real maximum power P_{max.r}. Thus, the cut-off power P_{co} subsequently calculated according to the maximum power Pₘₐₓ is greater than a real cut-off power P_{co.r}, a difference Diff between the cut-off frequency indices I_{co}_{_}ᵣ and I_{co}_{_}ₗ is smaller than a real difference Diff.r between real cut-off frequency indices I_{co}_{_}_{r.r} and I_{co}_{_}_{l.r}, and the symbol rate SR calculated according to the difference Diff between the cut-off frequency indices I_{co}_{_}ᵣ and I_{co}_{_}ₗ is smaller than a real symbol rate, leading to lowered accuracy in the symbol rate estimated by the symbol rate estimation device 10.

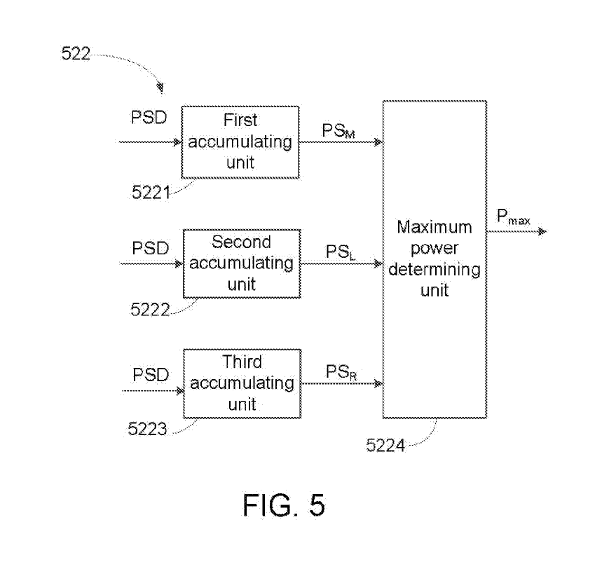

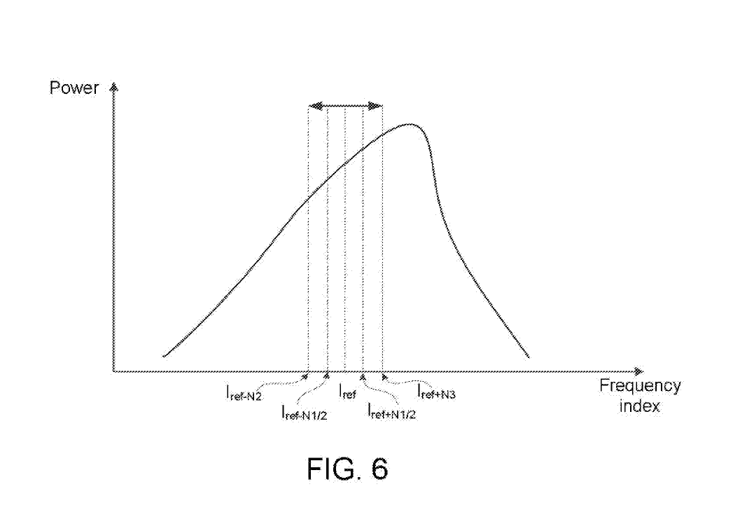

FIG. 5 shows a block diagram of a maximum power outputting unit 522 according to an embodiment of the present invention. The maximum power outputting unit 522 includes a first accumulating unit 5221, a second accumulating unit 5222, a third accumulating unit 5223 and a maximum power determining unit 5224. FIG. 6 shows a schematic diagram of an example of an imbalanced PSD. The first accumulating unit 5221 accumulates powers corresponding to (N1+1) frequency indices regarding a reference frequency index I_{ref} as a center to output a middle power sum PS_{M}. The middle power sum PS_{M} may be represented by equation (2):

PS_{M}=Σ_{i=I}_{_{ref-N1/2}}^{i=I}^{_{ref+N1/2}}P(i) (2)

In equation (2), P(i) is the power corresponding to the i^{th} frequency index.

The second accumulating unit 5222 accumulates powers corresponding to (N2+1) frequency indices on the left side of the reference frequency index I_{ref} to output a left-hand power sum PS_{L}. The left-hand power sum PS_{L} may be represented by equation (3):

PS_{L}=Σ_{i=I}_{_{ref-N2}}^{i=I}^{_{ref}}P(i) (3)

The third accumulating unit 5223 accumulates powers corresponding to (N3+1) frequency indices on the right side of the reference frequency index I_{ref} to output a right-hand power sum PS_{R}. The right-hand power sum PS_{R} may be represented by equation (4):

PS_{R}=Σ_{i=I}_{_{ref}}^{i=I}^{_{ref+N3}}P(i) (4)

In one embodiment, the reference frequency index I_{ref} is FFT_size/2, and the values N1, N2 and N3 may be designed according to requirements. In one embodiment, N1=N2=N3, and the frequency indices (I_{ref-N} to I_{ref-N}) are the search range RNG shown in FIG. 2.

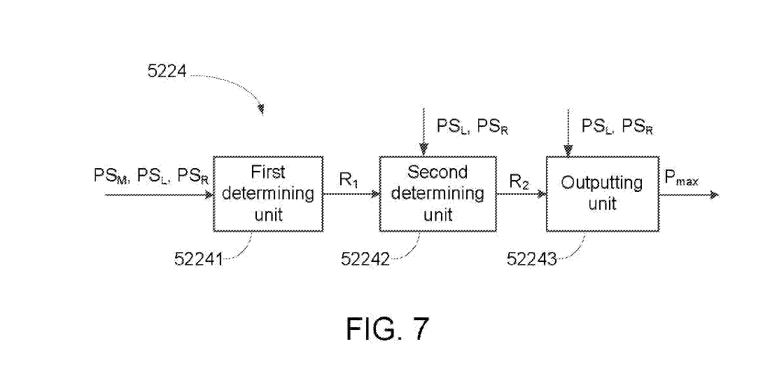

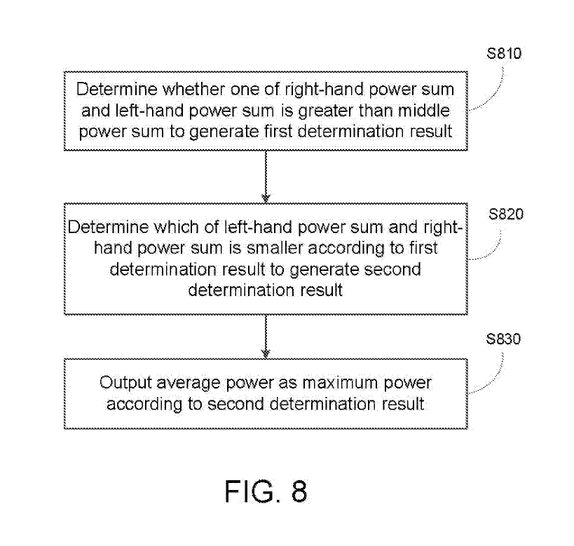

The maximum power determining unit 5224 determines the maximum power Pₘₐₓ according to the middle power sum PS_{M}, the left-hand power sum PS_{L} and the right-hand power sum PS_{R}. FIG. 7 shows a block diagram of the maximum power determining unit 5224 according to an embodiment of the present invention. FIG. 8 shows a flowchart of a maximum power determining method according to an embodiment of the present invention. Referring to FIG. 7 and FIG. 8, the maximum power determining unit 5224 includes a first determining unit 52241, a second determining unit 52242 and an outputting unit 52243. The first determining unit 52241 determines whether one of the left-hand power sum PS_{L} and the right-hand power sum PS_{R} is greater than the middle power sum PS_{M} to generate a first determination result R1 (step S810). For example, assuming that the PSD inclines towards the right side (as shown in FIG. 6), when the first determining unit 52241 determines that the right-hand power sum PS_{R} is greater than the middle power sum PS_{M}, the first determining unit 52241 generates the first determination result R1 to the second determining unit 52242. The second determining unit 52242 determines which of the left-hand power sum PS_{L} and the right-hand power sum PS_{R} is smaller according to the first determination result R1 to generate a second determination result R2 (step S820). In continuation of the above example, the second determining unit 52242 determines which of the left-hand power sum PS_{L} and the right-hand power sum PS_{R} is smaller according to the first determination result R1 indicating that the right-hand power sum PS_{R} is greater than the middle power sum PSM; when the second determining unit 52242 determines that the left-hand power sum PS_{L} is smaller than the right-hand power sum PS_{R}, the second determining unit 52242 generates the corresponding second determination result R2 to the outputting unit 52243. The outputting unit 52243 eventually outputs an average power according to the second determination result R2 to serve as the maximum power Pₘₐₓ (step S830). In continuation of the above example, the outputting unit 52243 outputs, according to the second determination result R2 indicating that the left-hand power sum PS_{L} is smaller than the right-hand power sum PS_{R}, an average power to serve as the maximum power Pₘₐₓ. In one embodiment, the outputting unit 52243 outputs an average PA_{L} of the left-hand power sum PS_{L} as the maximum power Pₘₐₓ, wherein the average PA_{L} of the left-hand power sum PS_{L} may be represented by equation (5):

PA_{L}=PS_{L}/(N2+1) (5)

For another example, assuming that the PSD inclines towards the left side, when the first determining unit 52241 determines that the left-hand power sum PS_{L} is greater than the middle power sum PS_{M}, the first determining unit 52241 generates the corresponding first determination result R1 to the second determining unit 52241. Next, the second determining unit 52242 determines which of the left-hand power sum PS_{L} and the right-hand power sum PS_{R} is smaller according to the first determination result R1 indicating that the left-hand power PS_{L} is greater than the middle power sum PS_{M}; when the second determining unit 52242 determines that the right-hand power sum PS_{R} is smaller than the left-hand power sum PS_{L}, the second determining unit 52242 generates the corresponding second determination result R2 to the outputting unit 52243. The outputting unit 52243 eventually outputs, according to the second indication result R2 indicating that the right-hand power sum PS_{R} is smaller than the left-hand power sum PS_{L}, an average power to serve as the maximum power Pₘₐₓ. In one embodiment, the outputting unit 52243 outputs an average PA_{R} of the right-hand power sum PS_{R} as the maximum power Pₘₐₓ, and the average PA_{R} of the right-hand power sum PS_{R} may be represented by equation (6):

PA_{R}=PS_{R}/(N3+1) (6)

As such, even in the presence of imbalance in a PSD, compared to the maximum power outputting unit 122, the maximum power Pₘₐₓ outputted by the maximum output unit 522 is closer to the real maximum power P_{max.r}. Thus, the symbol rate estimation device (not shown) provided with the maximum power outputting unit 522 is capable of more accurately estimating a symbol rate. It should be noted that, except for the maximum power outputting unit 522, other elements in the symbol rate estimation device 50 are identical to those in the symbol rate estimation device 10, and such repeated details shall be omitted herein.

It should be noted that, in the above embodiments, when the left-hand power sum PS_{L} is smaller than the right-hand power sum PS_{R}, the outputting unit 52243 outputs the average PA_{L} of the left-hand power sum PS_{L} as the maximum power Pₘₐₓ. The present invention is not limited to such example. In other embodiments, when the left-hand power sum PS_{L} is smaller than the right-hand power sum PS_{R}, the outputting unit 52243 may output an average power associated with the power corresponding to at least one frequency index on the left side of the reference frequency index I_{ref} as the maximum power Pₘₐₓ.

It should be noted that, in the above embodiments, when the right-hand power sum PS_{R} is smaller than the left-hand power sum PS_{L}, the outputting unit 52243 outputs the average of the right-hand power sum PS_{R} as the maximum power Pₘₐₓ. The present invention is not limited to such example. In other embodiments, when the right-hand power sum PS_{R} is smaller than the left-hand power sum PS_{L}, the outputting unit 52243 may output an average power as the maximum power Pₘₐₓ, wherein the average power is associated with the power corresponding to at least one frequency index on the right side of the reference frequency index I_{ref}.

In conclusion, the present invention determines a maximum power according to a middle power sum, a left-hand power sum and a right-hand power sum of a PSD, thus enhancing the accuracy for estimating a symbol rate in the presence of an imbalanced PSD.

While the invention has been described by way of example and in terms of the embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A symbol rate estimation device, comprising:
a power spectrum density (PSD) generating unit, estimating a power of an input signal to generate a PSD, which includes a plurality of powers respectively corresponding to a plurality of frequency indices;
a cut-off frequency index outputting unit, outputting a cut-off frequency index according to the PSD; and
a symbol rate calculating unit, calculating a symbol rate of the input signal according to the cut-off frequency index.

2. The symbol rate estimation device according to claim 1, wherein the cut-off frequency outputting unit comprises:
a maximum power outputting unit, outputting a maximum power according to the PSD;
a noise power outputting unit, outputting a noise power according to the PSD;
a cut-off power calculating unit, calculating a cut-off power according to the maximum power and the noise power; and
an index outputting unit, outputting a frequency index corresponding to the cut-off power as the cut-off frequency index.

3. The symbol rate estimation device according to claim 2, wherein the maximum power outputting unit comprises:
a first accumulating unit, accumulating powers corresponding to (N1+1) frequency indices by regarding a reference frequency index as a center to output a middle power sum;
a second accumulating unit, accumulating powers corresponding to (N2+1) frequency indices on a left side of the reference frequency index to output a left-hand power sum;
a third accumulating unit, accumulating powers corresponding to (N3+1) frequency indices on a right side of the reference frequency index to output a right-hand power sum; and
a maximum power determining unit, determining the maximum power according to the middle power sum, the left-hand power sum and the right-hand power sum.

4. The symbol rate estimation device according to claim 3, wherein the maximum power determining unit comprises:
a first determining unit, determining whether one of the left-hand power sum and the right-hand power sum is greater than the middle power sum to generate a first determination result;
a second determining unit, determining which of the left-hand power sum and the right-hand power sum is greater according to the first determination result to generate a second determination result; and
an outputting unit, outputting an average power as the maximum power according to the second determination result.

5. The symbol rate estimation device according to claim 4, wherein when the second determination indicates that the left-hand power sum is smaller than the right-hand power sum, the average power is associated with a power corresponding to at least one frequency index on the left side of the reference frequency index.

6. The symbol rate estimation device according to claim 4, wherein when the second determination result indicates that the right-hand power sum is smaller than the left-hand power sum, the average power is associated with a power corresponding to at least one frequency index on the right side of the reference frequency index.

7. The symbol rate estimation device according to claim 3, wherein the reference frequency index is FFT_size/2, and FFT_size is a resolution that the PSD generating unit uses to perform Fourier transform on the input signal.

8. A symbol rate estimation method, comprising:
estimating a power of an input signal to generate a PSD, which includes a plurality of powers respectively corresponding to a plurality of frequency indices;
outputting a cut-off frequency index according to the PSD; and
calculating a symbol rate of the input signal according to the cut-off frequency index.

9. The symbol rate estimation method according to claim 8, wherein the step of outputting the cut-off frequency index according to the PSD comprises:
outputting a maximum power according to the PSD;
outputting a noise power according to the PSD;
calculating a cut-off power according to the maximum power and the noise power; and
outputting a frequency index corresponding to the cut-off power as the cut-off frequency index.

10. The symbol rate estimation method according to claim 9, wherein the step of outputting the maximum power according to the PSD comprises:
accumulating powers corresponding (N1+1) frequency indices regarding a reference frequency index as a center to output a middle power sum;
accumulating powers corresponding to (N2+1) frequency indices on a left side of the reference frequency index to output a left-hand power sum;
accumulating powers corresponding to (N3+1) frequency indices on a right side of the reference frequency index to output a right-hand power sum; and
determining the maximum power according to the middle power sum, the left-hand power sum and the right-hand power sum.

11. The symbol rate estimation method according to claim 10, wherein the step of determining the maximum power according to the middle power sum, the left-hand power sum and the right-hand power sum comprises:
determining whether one of the left-hand power sum and the right-hand power sum is greater than the middle power sum to generate a first determination result;
determining which of the left-hand power sum and the right-hand power sum is greater according to the first determination result to generate a second determination result; and
outputting an average power as the maximum power according to the second determination result.

12. The symbol rate estimation method according to claim 11, wherein when the second determination indicates that the left-hand power sum is smaller than the right-hand power sum, the average power is associated with a power corresponding to at least one frequency index on the left side of the reference frequency index.

13. The symbol rate estimation method according to claim 11, wherein when the second determination result indicates that the right-hand power sum is smaller than the left-hand power sum, the average power is associated with a power corresponding to at least one frequency index on the right side of the reference frequency index.

14. The symbol rate estimation method according to claim 10, wherein the reference frequency index is FFT_size/2, and FFT_size is a resolution according to which Fourier transform is performed on the input signal.
